(19) United States
(12) Patent Application Publication
(10) Pub. No.: US 2021/0054893 A1
(43) Pub. Date: Feb. 25, 2021

(54) METHOD FOR REDUCING THE FLATTENING OF A WHEEL BRAKE DISK FOR A RAIL VEHICLE AND DEVICE FOR CARRYING OUT SAID METHOD

(71) Applicant: KNORR-BREMSE SYSTEME FÜR SCHIENENFAHRZEUGE GMBH, Munich (DE)

(72) Inventors: Christian MOSBACH, Alling (DE); Bernhard HÄMMERL, Maisach (DE); Marc-Gregory ELSTORPFF, Mumich (DE); Thomas VOLK, Weingarten (DE)

(21) Appl. No.: 16/982,435

(22) PCT Filed: Feb. 28, 2019
(86) PCT No.: PCT/EP2019/055048

§ 371 Date: Sep. 18, 2020

(30) Foreign Application Priority Data
Mar. 21, 2018 (DE) 10 2018 106 609.0

(51) Int. Cl. F16D 65/12

(52) U.S. Cl. CPC F16D 65/124; F16D 2250/0023

(57) ABSTRACT

A method and device reduce the flattening of a wheel brake disk for a rail vehicle, caused by braking processes, includes, after determination of a deviation of a friction surface of the brake disk from a plane defined by a peripheral edge of the friction surface, the friction surface of the wheel brake disk is permanently molded back into the plane defined by the peripheral edge of the friction surface.

### CROSS REFERENCE AND PRIORITY CLAIM

This patent application is a U.S. National Phase of International Patent Application No. PCT/EP2019/055048 filed Feb. 28, 2019, which claims priority to German Patent Application No. 10 2018 106 609.0, the disclosure of which being incorporated herein by reference in their entireties.

### FIELD

Disclosed embodiments relate to a method and device for reducing the flattening of a wheel brake disk for a rail vehicle which has occurred as a result of braking operations.

### BACKGROUND

Such wheel brake disks for rail vehicles are secured at both sides of a rail wheel of a rail vehicle with a large number of peripherally distributed through-bolts. The wheel brake disk is retained on the wheel member by the screw connection.

### SUMMARY

Disclosed embodiments provide a method and device for reducing the flattening of a wheel brake disk for a rail vehicle by which wheel brake disks with relatively great flattening values can also be reused.

Disclosed embodiments also provide a method and device for reducing the flattening of a wheel brake disk for a rail vehicle by which wheel brake disks with relatively great flattening values can also be reused.

### BRIEF DESCRIPTION OF THE FIGURES

Disclosed embodiments are explained in greater detail below with reference to the appended drawings, in which:

FIG. 1 is a perspective illustration of an outer ring of a device,

FIG. 2 is a sectioned view through the outer ring along a line designated II-II in FIG. 1,

FIG. 3 is an enlarged view of the section of the outer ring shown in FIG. 2,

FIG. 4 is a perspective illustration of a ground inner ring, and

FIG. 5 is a perspective illustration of a construction variant of an upper stamp of the device.

### DETAILED DESCRIPTION

Particularly with so-called emergency brake systems, there are significant temperature increases of the wheel brake disk, which leads to a plate-like deformation of the brake disk. Such deformation behavior is also referred to as flattening. Such a flattening of the wheel brake disk can after a relatively long running time lead to thickness fluctuations or locally high thermal loads which should be avoided to the greatest possible extent.

As a result of the screw connection, in the tightened state of the wheel brake disk only a slightly pronounced flattening may occur since the expansion screws which are used for the screw connection largely hold the wheel brake disk in its original shape.

In wheel brake disks of rail vehicles, the service-lives of the wheel brake disks are often considerably greater than the service-lives of the rail wheels so that partially worn wheel brake disks of a worn rail wheel are mounted on a new rail wheel.

However, such a re-mounting is only technically possible and permissible up to a specific degree of flattening of the wheel brake disks.

In order to reduce such flattening which has occurred as a result of braking operations in respect of a wheel brake disk, it is known from the prior art to over-rotate the friction face of the wheel brake disk in order to reduce any near-surface inherent tensions of the wheel brake disk present. It is thereby possible to overcome residual flattening of the wheel brake disk when the wheel brake disk is screwed to the rail wheel.

It is problematic when the flattening of the wheel brake disk exceeds a degree of flattening which cannot be reduced by over-rotating to such an extent that by screwing the wheel brake disk a planar friction face can be achieved.

Disclosed embodiments provide a method and device for reducing the flattening of a wheel brake disk for a rail vehicle by which wheel brake disks with relatively great flattening values can also be reused.

Disclosed embodiments provide a method and device for reducing the flattening of a wheel brake disk for a rail vehicle by which wheel brake disks with relatively great flattening values can also be reused.

In accordance with the disclosed embodiments, after determining a deviation of a friction face of the wheel brake disk from a plane defined by a peripheral edge of the friction face, the friction face of the wheel brake disk is permanently deformed back into the plane defined by the peripheral edge of the friction face.

This enables the inherent tensions of the wheel brake disk generated by the heat which has been produced during a braking operation to be mechanically deformed back by an application of excess pressure to the wheel brake disk in a direction counter to the flattening which has occurred.

The re-mounting rate of partially worn wheel brake disks can thereby be considerably increased.

Optionally, disclosed embodiments may include:
a. placing the wheel brake disk in a lower stamp;
b. lowering an upper stamp onto a radially inner part-face of the friction face of the wheel brake disk until the radially inner part-face of the friction face of the wheel brake disk is deformed back into the plane defined by the peripheral edge of the friction face.

Optionally, disclosed embodiments may include, prior to operation a), carrying out an orientation of the lower stamp such that a support face of the lower stamp counter to the flattening of the wheel brake disk forms a recess, wherein the depth of the recess is adjusted in accordance with the deviation of the friction face of the wheel brake disk from the plane defined by the peripheral edge of the friction face.

Optionally, disclosed embodiments may include carrying out orientation of a two-part lower stamp with a circle-like or circular inner support and an outer ring which surrounds the inner support such that an annular bearing face of the outer ring is increased with respect to the inner support by an extent which is adapted to the measured extent of flattening or warpage.

Such a two-part lower stamp can be produced in a cost-effective manner and enables in a simple method step the depth of the excess pressure to be adjusted in a simple manner so that a path-controlled application of excess pressure is thereby enabled.

Optionally, disclosed embodiments may include, in operation b), lowering the upper stamp onto the radially inner edge region of the friction face of the wheel brake disk until the radially inner edge region of the friction face of the wheel brake disk rests on the inner support.

As a result of such a time-limited application of excess pressure to the wheel brake disk, the inherent tensions of the wheel brake disk can be reduced to such an extent that a subsequent secure screwing of the partially worn wheel brake disk on the wheel of the rail vehicle is enabled again.

Optionally, disclosed embodiments may include, it is also conceivable to measure the deviation of the friction face of the wheel brake disk from a plane defined by a peripheral edge of the friction face beforehand.

Optionally, disclosed embodiments may include, prior to operation a), pre-processing the friction face of the wheel brake disk in a machining manner to reduce near-surface inherent tensions.

It thereby also becomes possible for wheel brake disks with more significant flattening to be pre-processed by the machining processing operation of the friction face of the wheel brake disk in such a manner that, when excess pressure is subsequently applied, the flattening of the wheel brake disk can be reduced to a permissible level.

In accordance with the disclosed embodiments, the device has a lower stamp and an upper stamp which can be displaced in the direction of the lower stamp. The lower stamp has a recess-like support face which can be adjusted in terms of its depth with respect to an annular outer edge of the lower stamp. The upper stamp has a pressing face, whose diameter is smaller than the inner diameter of the annular outer edge of the lower stamp.

By placing the upper stamp on the wheel brake disk placed in the lower stamp, it is thereby possible to apply excess pressure to the wheel brake disk counter to the flattening thereof.

Optionally, the lower stamp is constructed in several parts, having an outer ring which forms the annular outer edge of the lower stamp and at least one inner ring which can be placed in the outer ring.

In this instance, the thickness of the outer ring is greater than the thickness of the inner ring, wherein, when the brake disk rests on the outer ring, excess pressure can be applied to it to a desired, predetermined extent counter to the flattening toward the inner ring of the lower stamp.

Optionally, the device has a large number of such inner rings of the same diameter, but with different thicknesses. It is thereby made possible for excess pressure to be applied sufficiently with the device to wheel brake disks with different extents of flattening. The height of the step between the inner ring and the outer ring of the lower stamp is in this instance possible by replacing and inserting an inner ring with a predetermined thickness in a simple manner.

Optionally, the outer ring may be placed on an inner ring or inner cylinder which can, for example, be hydraulically displaced, wherein the inner ring or inner cylinder depending on the degree of flattening of the wheel brake disk which is intended to be processed forms a suitable step relative to the support face of the outer ring.

In place of such an operation in the lower stamp between the outer ring and inner ring, it is also conceivable for the support face of the lower stamp to be formed so as to continuously decline in a radially inward direction.

In the following description of the figures, terms such as top, bottom, left, right, front, rear, etcetera, refer exclusively to the exemplary illustration and position of the wheel brake disk, the outer ring, the inner ring, the upper stamp and the like, as selected in the respective figures. These terms are not intended to be understood to be limiting, that is to say, these references can change as a result of different operating positions or the mirror-symmetrical configuration or the like.

In the method according to disclosed embodiments, after determining a deviation of a friction face of the wheel brake disk from a plane defined by a peripheral edge of the friction face, the friction face of the wheel brake disk is permanently deformed back into the plane defined by the peripheral edge of the friction face.

A “deviation of a friction face of the wheel brake disk from a plane defined by a peripheral edge of the friction face” is in this instance intended to be understood to refer to a deformation of the friction face of the wheel brake disk from an originally planar state, in which the friction face is located in a plane defined by the peripheral edge of the friction face into a state in which the friction face at least partially protrudes from this plane and in particular is curved in a plate-like manner.

In this instance, the determination of such a deviation of the friction face of the wheel brake disk from a plane defined by a peripheral edge of the friction face can be carried out, for example, in the form of a statistical analysis of the used wheel brake disk. With such a statistical analysis, for example, it is determined that all the wheel brake disks after use have a deviation which is in a specific range, for example, in a range from 0.4 mm to 0.7 mm.

Alternatively, the determination of such a deviation of the friction face of the wheel brake disk from a plane defined by a peripheral edge of the friction face can also be carried out with respective visual examination with or without subsequent measurement of the wheel brake disk.

Finally, a measurement of such a deviation of the friction face of the wheel brake disk from a plane defined by a peripheral edge of the friction face is also conceivable as an integral part of a method for reducing the flattening of a wheel brake disk for a rail vehicle which has occurred as a result of braking operations.

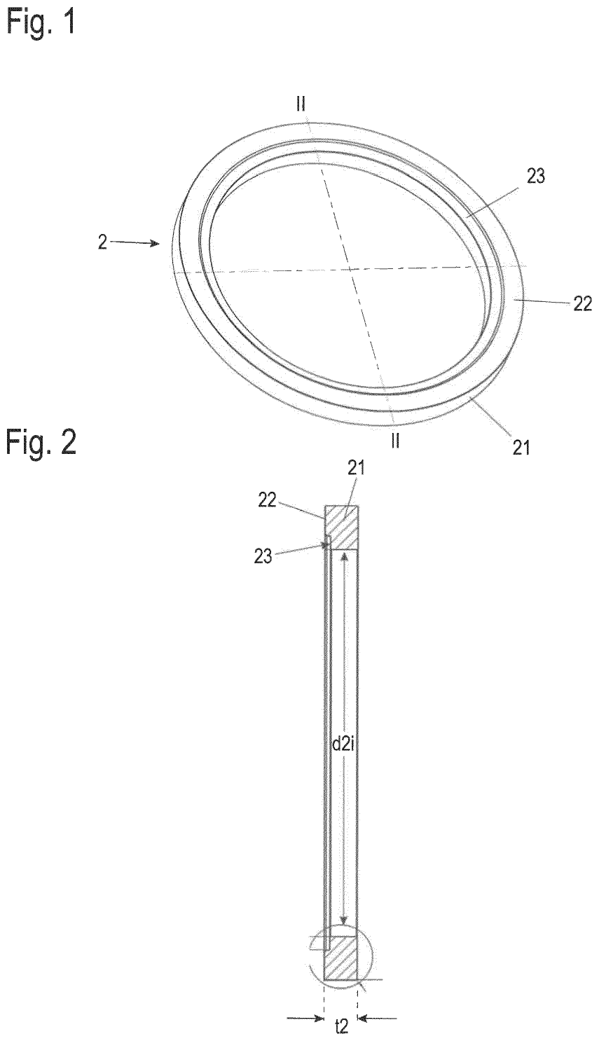

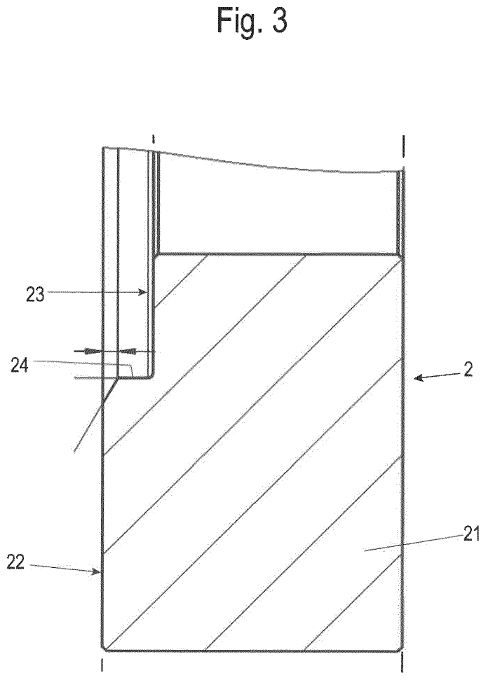

FIGS. 1 to 5 illustrate components of a device for carrying out a method for reducing the flattening of a wheel brake disk for a rail vehicle which has occurred as a result of braking operations.

In this instance, FIGS. 1-3 show an outer ring 2 as a component of a lower stamp of the device.

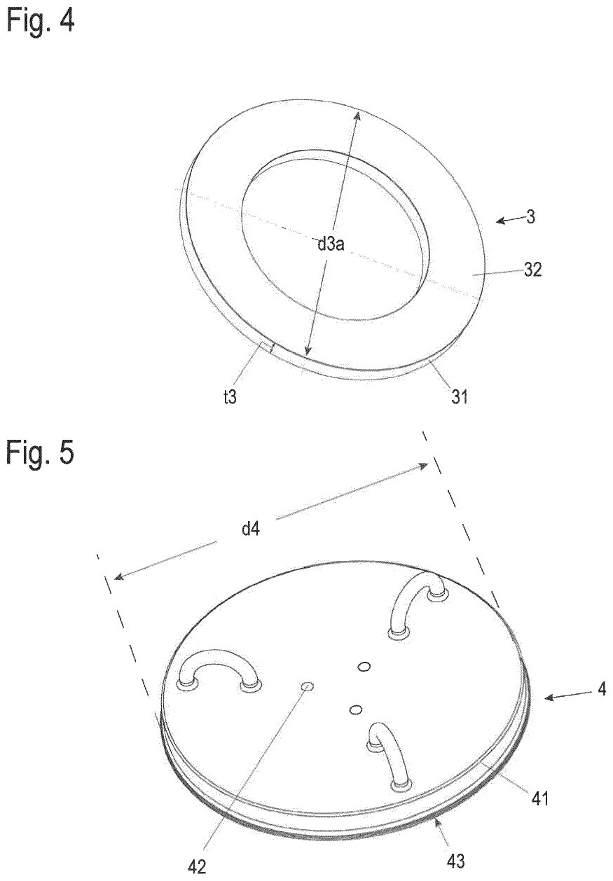

FIG. 4 shows an inner ring 3 which can be placed in the outer ring 2 as a component of the lower stamp of the device.

FIG. 5 shows an upper stamp 4 which serves to place a flattened or warped wheel brake disk (not shown) after placing in the lower stamp which is shown in FIGS. 1-4 and, by pressing the upper stamp 4 in a direction perpendicular to the pressing face 43 of the upper stamp 4, to apply excess pressure to the wheel brake disk.

As shown in FIGS. 1-3, the outer ring 2 has an annular base member 21 which is constructed to be stepped in a radially inner region. In this case, the region of the outer ring 2 with the radially external outer step 22 has a thickness t₂ which is greater than a thickness t₃ of the inner ring 3 shown by way of example in FIG. 4.

The thicknesses are in this instance measured in a direction perpendicular to a plane defined by the peripheral edge of the outer ring 2 or the inner ring 3.

In the construction variant shown here, the inner ring 3 comprises an annular member 31 with a cylindrical outer and inner edge and a planar bearing face 32. The thickness t₃ of the inner ring 3 is in this instance constant over the entire annular member 31.

The one inner step of the outer ring 2 is constructed as a bearing face 23 for supporting a radially outer region of a wheel brake disk which is intended to be processed.

The inner edge 24 which is formed perpendicularly to the bearing face 23 at the transition to the outer step 22 is used in this instance to precisely concentrically support the wheel brake disk which is intended to be processed.

The diameter d₂ᵢ of the annular opening of the outer ring 2 is optionally dimensioned in such a manner that the inner ring 3 can be placed precisely or almost in a play-free manner therein in order to ensure a concentric arrangement of the outer ring 2 with respect to the inner ring 3.

The device optionally has a large number of such inner rings 3 which differ from each other only in terms of their thicknesses t₃ so that depending on the degree of flattening of the wheel brake disk a corresponding inner ring 3 can be placed in the outer ring 2, wherein the thickness of the inner ring 3 determines the extent of the excess pressure applied to the wheel brake disk by the upper stamp 4.

In addition to the construction variants of the outer ring 2 and the inner ring 3 shown herein, it is also conceivable for the bearing face 23 of the outer ring 2 and/or the bearing face 32 of the inner ring 3 to be formed so as to decline continuously in a radially inward direction.

It is also conceivable, in place of the inner ring 3, to provide a lower stamp which has a recess-like support face which can be adjusted with respect to an annular outer edge of the lower stamp in terms of its depth and which, for example, can be adjusted hydraulically in relation to the bearing face 23 of the outer ring 2 in terms of its height in accordance with the extent of the flattening of the wheel brake disk which is intended to be processed.

In the method according to disclosed embodiments for reducing the flattening of a wheel brake disk for a rail vehicle, in a first step the deviation of a friction face of the wheel brake disk from a plane defined by a peripheral edge of the friction face is optionally measured. It is also conceivable, as mentioned further above, to statistically detect the deviation beforehand.

Subsequently, the lower stamp is orientated in such a manner that a support face of the lower stamp counter to the flattening of the wheel brake disk forms a recess. The depth of the recess is in this instance adjusted in accordance with the deviation of the friction face of the wheel brake disk from the plane defined by the peripheral edge of the friction face.

Afterwards, the wheel brake disk is placed in the lower stamp in such a manner that the flattening or warping of the lower stamp faces away in the direction of the upper stamp 4 which is subsequently intended to be lowered onto the wheel brake disk.

The wheel brake disk rests in this instance with a radially outer edge on the lower side facing away from the friction face of the wheel brake disk.

Finally, the upper stamp 4 is lowered onto a radially inner part-face of the friction face of the wheel brake disk until the radially inner part-face of the friction face of the wheel brake disk rests on the support face of the lower stamp or touches it.

As a result of this application of excess pressure to the wheel brake disk, the inherent stresses produced as a result of the heating resulting from braking operations are mechanically formed back in the wheel brake disk.

It is thereby possible for the wheel brake disk after completed application of the excess pressure to be able to be secured again to a rail wheel of a rail vehicle, in particular screwed.

The orientation of the lower stamp is carried out in this instance in the case of the two-part lower stamp shown in FIGS. 1-4 in such a manner that the inner ring 3 or also a circular inner support and an outer ring 2 which surrounds this/these is/are orientated in such a manner that an annular bearing face 23 of the outer ring 2 is increased with respect to the inner ring 3 or the circular inner support by an extent which is adapted to the measured extent of flattening or warping.

It is also conceivable to omit the lower stamp and to lower the upper stamp 4 onto a radially inner part-face of the friction face of the wheel brake disk by a predetermined extent in order to form the friction face of the wheel brake disk back into the original planar form again.

With a particularly noticeable flattening of the wheel brake disk, it is also conceivable prior to the wheel brake disk being placed in the lower stamp to subject the friction face of the wheel brake disk to a machining processing operation in order to reduce near-surface inherent tensions initially or also in a method step following the application of excess pressure.

### LIST OF REFERENCE NUMERALS

2 Outer ring
21 Ring member
22 Outer step
23 Bearing face
24 Inner edge
3 Inner support
31 Annular member
32 Bearing face
4 Upper stamp
41 Pressure piece
42 Hole
43 Pressing face
d₂ᵢ Inner diameter
d₃ₐ Outer diameter
d₄ Outer diameter
t₂ Thickness
t₃ Thickness

1. A method for reducing the flattening of a wheel brake disk for a rail vehicle which has occurred as a result of braking operations, the method comprising:
in response to determining a deviation of a friction face of the wheel brake disk from a plane defined by a peripheral edge of the friction face, permanently deforming the friction face of the wheel brake disk back into the plane defined by the peripheral edge of the friction face.

2. The method of claim 1, further comprising:
placing the wheel brake disk in a lower stamp;
lowering an upper stamp onto a radially inner part-face of the friction face of the wheel brake disk until the radially inner part-face of the friction face of the wheel brake disk is deformed back into the plane defined by the peripheral edge of the friction face.

3. The method of claim 2, further comprising, prior to placing the wheel brake disk in the lower stamp, an orientation of the lower stamp is carried out such that a support face of the lower stamp counter to the flattening of the wheel brake disk forms a recess, wherein the depth of the recess is adjusted in accordance with the deviation of the friction face of the wheel brake disk from the plane defined by the peripheral edge of the friction face.

4. The method of claim 3, wherein orientation of a two-part lower stamp with a circular inner support and an outer ring which surrounds the inner support is carried out such that an annular bearing face of the outer ring is increased with respect to the inner support by an extent which is adapted to the measured extent of flattening or warpage.

5. The method of claim 4, wherein, in the lowering of the upper stamp onto the radially inner part-face of the friction face of the wheel brake disk, the upper stamp is lowered onto the radially inner edge region of the friction face of the wheel brake disk until the radially inner edge region of the friction face of the wheel brake disk rests on the inner support.

6. The method of claim 1, further comprising, prior to placing the wheel brake disk in the lower stamp, measuring a deviation of a friction face of the wheel brake disk from a plane defined by a peripheral edge of the friction face.

7. The method of claim 1, wherein, prior to placing the wheel brake disk in the lower stamp, the friction face of the wheel brake disk is subjected to a machining processing operation to reduce near-surface inherent tensions.

8. A device for reducing the flattening of a wheel brake disk for a rail vehicle which has occurred as a result of braking operations, the device comprising:
a lower stamp; and
an upper stamp which can be displaced in the direction of the lower stamp,
wherein the lower stamp has a recessed support face which can be adjusted in terms of its depth with respect to an annular outer edge of the lower stamp, and
wherein the upper stamp has a pressing face whose diameter is smaller than the inner diameter of the annular outer edge of the lower stamp.

9. The device of claim 8, wherein the lower stamp is constructed of a plurality of parts including an outer ring, which forms the annular outer edge of the lower stamp and at least one inner ring, which can be placed in the outer ring, wherein the thickness of the outer ring is greater than the thickness of the inner ring, wherein, when the brake disk rests on the outer ring, excess pressure is applied to a desired, predetermined extent counter to the flattening toward the inner ring of the lower stamp.

10. The device of claim 9, wherein a plurality of inner rings with the same diameter but with different thicknesses.

11. The device of claim 8, wherein the support face of the lower stamp is formed so as to decline in steps in a radially inward direction.

12. The device of claim 8 wherein the support face of the lower stamp is formed so as to continuously decline in a radially inward direction.

13. The device of claim 8, wherein the device places the wheel brake disk in the lower stamp and lowers the upper stamp onto a radially inner part-face of the friction face of the wheel brake disk until the radially inner part-face of the friction face of the wheel brake disk is deformed back into the plane defined by the peripheral edge of the friction face.

14. The device of claim 13, wherein, prior to placement of the wheel brake disk in the lower stamp, an orientation of the lower stamp is carried out such that the support face of the lower stamp counter to the flattening of the wheel brake disk forms the recess, wherein the depth of the recess is adjusted in accordance with the deviation of the friction face of the wheel brake disk from the plane defined by the peripheral edge of the friction face.

15. The device of claim 14, wherein orientation of a two-part lower stamp with a circular inner support and an outer ring which surrounds the inner support is carried out such that an annular bearing face of the outer ring is increased with respect to the inner support by an extent which is adapted to the measured extent of flattening or warpage.

16. The device of claim 15, wherein, in the lowering of the upper stamp onto the radially inner part-face of the friction face of the wheel brake disk, the upper stamp is lowered onto the radially inner edge region of the friction face of the wheel brake disk until the radially inner edge region of the friction face of the wheel brake disk rests on the inner support.

17. The device of claim 8, wherein, prior to placement of the wheel brake disk in the lower stamp, a deviation of a friction face of the wheel brake disk from a plane defined by a peripheral edge of the friction face is measured.

18. The device of claim 8, wherein, prior to placement the wheel brake disk in the lower stamp, the friction face of the wheel brake disk is subjected to a machining processing operation to reduce near-surface inherent tensions.
